(19) United States
(12) Patent Application Publication
(10) Pub. No.: US 2014/0318414 A1
(43) Pub. Date: Oct. 30, 2014

(54) NANO-METAL SOLUTION AND NANO-METAL COMPLEX GRAINS

(71) Applicant: Industrial Technology Research Institute, Hsinchu (TW)

(72) Inventors: Kuo-Chan Chiou, Tainan City (TW); Hong-Ching Lin, Kaohsiung City (TW); Szu-Po Huang, Taipei City (TW); Chun-An Lu, New Taipei City (TW)

(73) Assignee: Industrial Technology Research Institute, Hsinchu (TW)

(21) Appl. No.: 14/295,347

(22) Filed: Jun. 4, 2014

Related U.S. Application Data
(62) Division of application No. 12/651,207, filed on Dec. 31, 2009.

(30) Foreign Application Priority Data
Dec. 31, 2008 (TW) 97151826
Oct. 29, 2009 (TW) 98136681
Dec. 22, 2009 (TW) 98144307

(51) Int. Cl. C09D 7/12

(52) U.S. Cl. CPC C09D 7/1216
USPC 106/287.17; 106/287.18; 106/287.19; 106/403

(57) ABSTRACT

A nano-metal solution, nano-metal complex grains, and a manufacturing method of a metal film are provided. The nano-metal solution includes metal grains having an amount of 0.1˜30 wt %, metallic-organic self-decomposition molecules having an amount of 0.1˜50 wt % and having formula 1, and a solvent having an amount of 20˜99.8 wt %:

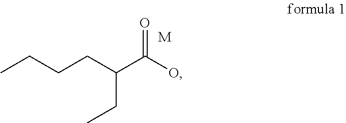

wherein M represents a metal ion. The metallic-organic self-decomposition molecules and the metal grains are evenly mixed in the solvent, and the metallic-organic self-decomposition molecules are adsorbed on surfaces of the metal grains.

### CROSS-REFERENCE TO RELATED APPLICATION

This is a divisional application of patent application Ser. No. 12/651,207, filed on Dec. 31, 2009, which claims the priority benefit of Taiwan application serial no. 97151826, filed on Dec. 31, 2008, Taiwan application serial no. 98136681, filed on Oct. 29, 2009, and Taiwan application serial no. 98144307, filed on Dec. 22, 2009. The entirety of each of the above-mentioned patent applications is hereby incorporated by reference herein and made a part of this specification.

### BACKGROUND OF THE INVENTION

1. Field of the Invention

The present invention relates to a metal solution, metal complex grains, and a manufacturing method of a metal film. More particularly, the present invention relates to a nano-metal solution, nano-metal complex grains, and a manufacturing method of a metal film.

2. Description of Related Art

With advancement of technologies in relation to grains in a nanometer scale, properties of the nano grains are studied by various industries for extensive application of the nano grains to different fields. For instance, nano-metal grains including nano-copper grains or nano-silver grains draw more and more attention in the photo-electronic industry on account of favorable electrical properties. In particular, owing to the trend of continuously pursuing photo-electronic products characterized by compactness, the tiny nano-metal grains have great potential for further development.

Currently, a number of methods for composing the nano-metal grains have been proposed. In general, metal ions dissolved in a solution are reduced to form the nano-metal grains by performing a reduction process. A melting point of the nano-metal grains is much lower than a melting point of a metal bulk material. Therefore, the nano-metal grains can be processed by performing a low-temperature baking process, e.g., a low-temperature sintering process, so as to form a metal film or a conductive pattern as required. In other words, it is not necessary to perform a conventional photolithography and etching process or a conventional electroplating process for forming the metal films with use of the nano-metal grains. As such, contamination and energy consumption caused by implementation of the photolithography and etching process or implementation of the electroplating process can be better prevented when the metal films are formed by means of the nano-metal grains.

In most cases, the nano-silver grains that are not apt to be oxidized are most applicable among all of the nano-metal grains. Nevertheless, costs of the nano-silver grains are relatively high. Moreover, silver migration often occurs when the nano-silver grains are exposed to moisture, such that reliability of the metal films formed by the nano-silver grains is negatively affected. Consequently, in consideration of costs and efficacy of finished products, manufacturers are still looking for a substitute material for improving capacity and quality of the products. On the other hand, the nano-copper grains featuring lower costs are frequently used as well. However, the nano-copper grains are easily oxidized, which results in certain issues to be resolved during actual applications of the nano-copper grains.

### SUMMARY OF THE INVENTION

The present invention is directed to a nano-metal solution in which metallic-organic self-decomposition (MOD) molecules are absorbed and attached to surfaces of nano-metal grains. Thereby, the nano-metal grains in the nano-metal solution are rather stable and are apt to be preserved.

The present invention is further directed to nano-metal complex grains which are not prone to cause ion migration. Besides, oxidation of metal grains in the nano-metal complex grains rarely arises, such that the nano-metal complex grains of the present invention are characterized by satisfactory quality.

The present invention is further directed to a manufacturing method of a metal film with satisfactory quality.

In the present invention, a nano-metal solution is provided. The nano-metal solution includes a plurality of metal grains having an amount of 0.1˜30 wt %, a plurality of metallic-organic self-decomposition (MOD) molecules having an amount of 0.1˜50 wt % and having formula 1, and a solvent having an amount of 20˜99.8 wt %:

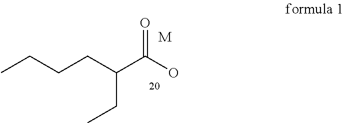

wherein M represents a metal ion. The MOD molecules and the metal grains are evenly mixed in the solvent, and the MOD molecules are adsorbed on surfaces of the metal grains.

In the present invention, a nano-metal complex grain including a plurality of metal grains, a metal layer, and an alloy layer is provided as well. The metal layer covers surfaces of the metal grains. The alloy layer is located between the metal grains and the metal layer. Here, the alloy layer is an alloy of the metal grains and the metal layer, and the metal grains are bonded together.

In the present invention, a manufacturing method of a metal film is also provided. The manufacturing method includes following steps. First, a nano-metal solution is fabricated. The nano-metal solution includes a plurality of metal grains having an amount of 0.1˜30 wt %, a plurality of MOD molecules having an amount of 0.1˜50 wt % and having formula 1, and a solvent having an amount of 20˜99.8 wt %:

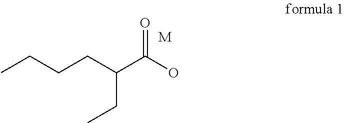

wherein M represents a metal ion. The MOD molecules and the metal grains are evenly mixed in the solvent, and the MOD molecules are adsorbed on surfaces of the metal grains. Next, the nano-metal solution is formed on a substrate. Thereafter, a sintering process is performed to self-decompose the MOD molecules so as to form a metal layer on the surfaces of the metal grains by the metal ions of the MOD molecules and form an alloy layer between the metal grains and the metal layer. Here, the alloy layer is an alloy of the metal grains and the metal layer.

Based on the above, the MOD molecules are added to the nano-metal solution according to the present invention, such that the MOD molecules are absorbed on the surfaces of the nano-metal grains. Thereby, after the sintering process is performed on the nano-metal solution, a thin alloy layer and a metal layer are formed on the surfaces of the nano-metal grains according to the present invention, so as to protect the nano-metal grains. As such, the nano-metal complex grains of the present invention are not apt to be oxidized, and electromigration does not often occur. On the other hand, the metal film formed by the nano-metal complex grains of the present invention can be equipped with favorable electrical properties.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1 to 4 illustrate a manufacturing method of a metal film according to an embodiment of the present invention.

FIG. 5 is a picture of metal grains and MOD molecules according to an embodiment of the present invention.

### DESCRIPTION OF EMBODIMENTS

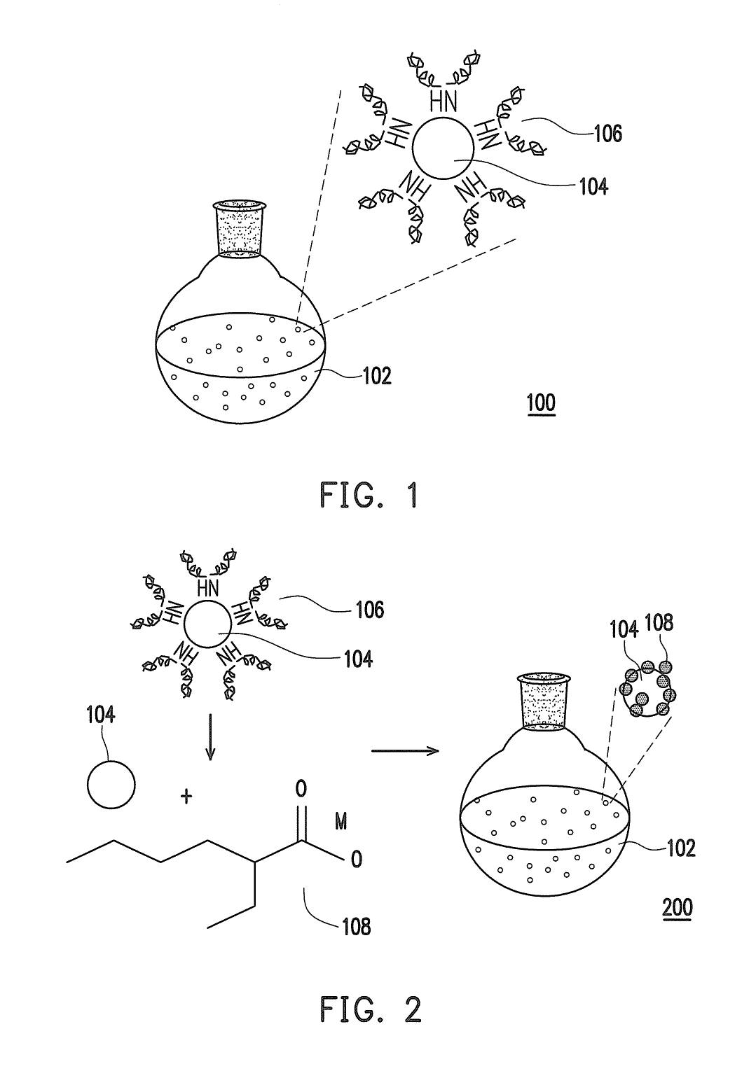

FIGS. 1 to 4 illustrate a manufacturing method of a metal film according to an embodiment of the present invention. Referring to FIG. 1, a preparation solution 100 is prepared. The preparation solution 100 is prepared by mixing a metal salt, a reducing agent, and a protecting agent 106 into a solvent 102. During preparing the preparation solution 100, the metal salt and the reducing agent are reacted so as to form metal grains 104, and the protecting agent 106 is absorbed on surfaces of the metal grains 104.

Here, the solvent 102 includes water or an organic solvent. For instance, the solvent 102 can be methanol, ethanol, ethylene glycol, isopropyl alcohol, terpineol, or a combination thereof.

The protecting agent includes polyvinyl pyrrolidone, polyvinyl alcohol, dodecylmercaptan, an organic siloxane coupling agent, or a combination thereof.

The metal salt comprises copper sulfate, copper nitrate, copper chloride, cooper acetate, silver nitrate, gold chloride, or a combination thereof.

The reducing agent includes ascorbic acid, citric acid, KBH₄, NaH₂PO₂.H₂O, NaBH₄, N₂H₄, NaOH, or a combination thereof.

When the metal salt is dissolved in the solvent 102, the metal salt is first dissociated to become metal cations and anions, and then the metal cations affected by the reducing agent become the metal grains 104. Based on the selected material of the metal salt, the metal grains 104 can be copper grains, silver grains, gold grains, aluminum grains, titanium grains, nickel grains, or a combination thereof. Besides, the metal grains 104 have diameters in a nanometer scale; for example, the diameters of the metal grains 104 are less than 100 nm. Generally, the nano-metal grains 104 are easily absorbed to one another, so as to form grains with relatively large diameters. In the present embodiment, the protecting agent 106 is added to the preparation solution 100, so as to separate the nano-metal grains 104. That is to say, when the protecting agent 106 is absorbed on the surfaces of the metal grains 104, the diameters of the metal grains 104 can remain in the nanometer scale, and the metal grains 104 can be stably distributed in the preparation solution 100.

Next, referring to FIG. 2, a cleaning process is performed, and then MOD molecules 108 are added to the preparation solution 100, so as to form a nano-metal solution 200. By performing the cleaning process, the protecting agent 106 attached to the surfaces of the metal grains 104 can be removed, and therefore the added MOD molecules 108 can be absorbed on the surfaces of the metal grains 104.

Here, the nano-metal solution 200 includes the metal grains 104 having an amount of 0.1˜30 wt % (preferably at 4 wt %), the MOD molecules 108 having an amount of 0.1˜50 wt % (preferably at 38 wt %) and having formula 1, and the solvent 102 having an amount of 20˜99.8 wt % (preferably at 58 wt %):

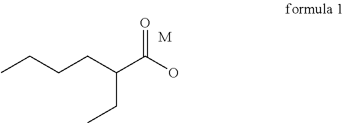

wherein M represents a metal ion.

According to the present embodiment, the metal ions M of the MOD molecules 108 include copper ions, silver ions, gold ions, aluminum ions, titanium ions, nickel ions, or a combination thereof. The metal ions M and the metal grains 104 are, for example, made of different metals. For instance, when the metal ions M of the MOD molecules 108 are silver ions, the metal grains 104 can be copper grains. Alternatively, when the metal ions M of the MOD molecules 108 are copper ions, the metal grains 104 can be silver grains. Said combinations of the metal grains and the metal ions do not constitute limitations to the present invention. In other embodiments, combinations of other kinds of metal grains and metal ions are applicable as long as the metal ions M and the metal grains 104 are made of different metals. Additionally, the MOD molecules 108 are self-decomposed at a temperature lower than 200° C.

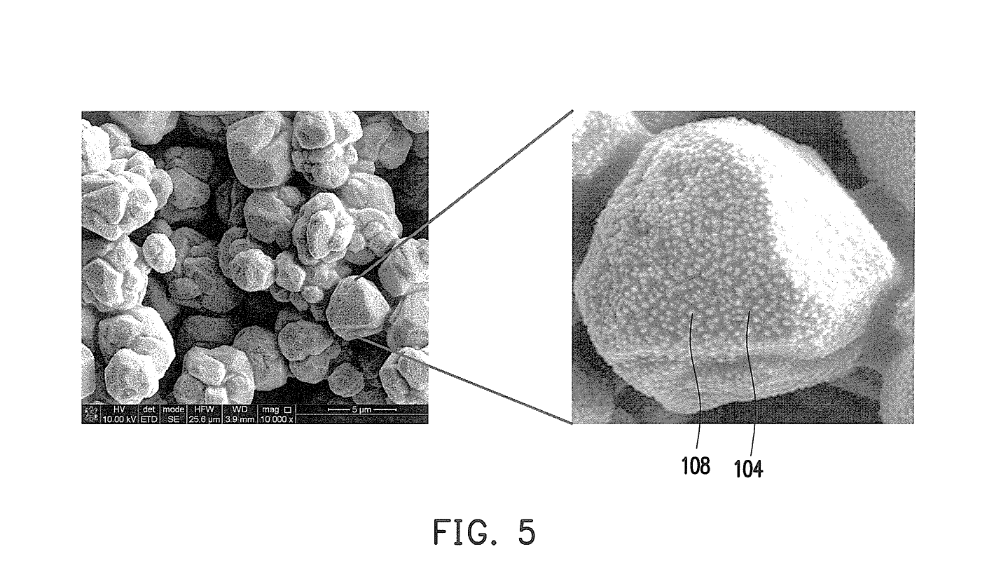

In the nano-metal solution 200, the MOD molecules 108 are contributive to ensure separability of the metal grains 104 and maintain diameters thereof. In practice, please refer to FIG. 5 which is a picture of metal grains and MOD molecules according to an embodiment of the present invention. As illustrated in FIGS. 2 and 5, during the preparation of the nano-metal solution 200, the MOD molecules 108 are absorbed on the surfaces of the metal grains 104, and therefore the MOD molecules 108 are conducive to separation of the metal grains 104. In the embodiment depicted in FIG. 5, the diameters of the MOD molecules 108 are, for example, less than 60 nm, the metal grains 104 are copper grains, and the MOD molecules 108 have formula 1 in which M represents Ag ion. Moreover, the temperature at which the MOD molecules 108 are self-decomposed can vary with modification of the composition of the solvent 102. Hence, during the preparation of the nano-metal solution 200, types of the solvent 102 can be determined upon actual demands.

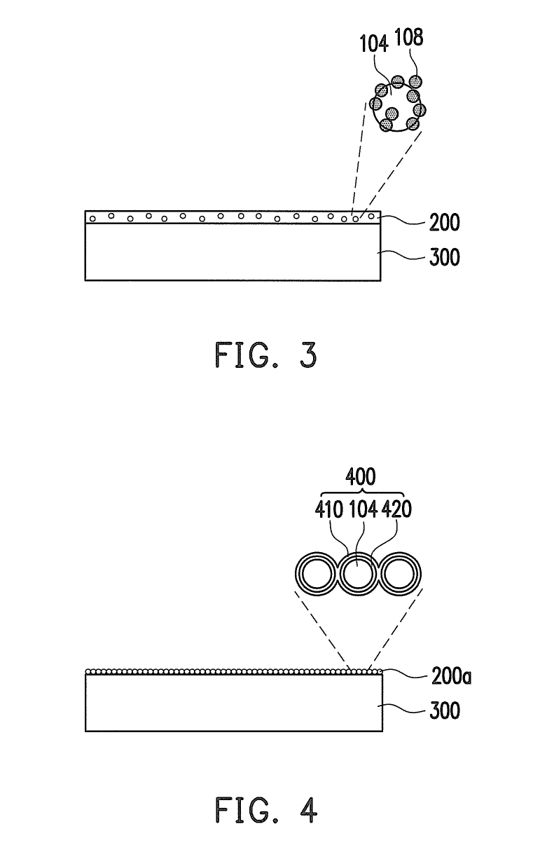

After the preparation of the nano-metal solution 200, the nano-metal solution 200 is formed on a substrate 300 as indicated in FIG. 3. In the present embodiment, a method of forming the nano-metal solution 200 on the substrate 300 includes a screen printing method, an inkjet printing method, a spin coating method, a die coating method, an offset printing method, a spray coating method, or the like. Practically, the nano-metal solution 200 can be selectively formed on the entire substrate 300 or on a predetermined area of the substrate 300. More particularly, the nano-metal solution 200 of the present embodiment can be regarded as ink comprising metal complex grains. Therefore, by conducting the printing method, the inkjet printing method, or other coating methods, the ink comprising the metal complex grains can be formed on specific positions of the substrate 300, so as to form a specific pattern, such as a conductive line pattern, an electrode pattern, or any other conductive pattern. However, the above description should not be construed as a limitation to the present invention. In other embodiments, the nano-metal solution can be coated onto the entire substrate, so as to form a film layer without patterns being formed thereon.

Thereafter, a sintering process is performed to form a metal film or a metal pattern 200a on the substrate 300, as shown in FIG. 4. The sintering process is performed at a temperature lower than 200° C., for example. A melting point of the metal grains 104 is lowered down to a great extent after the metal grains 104 become the nano-metal grains. Hence, the sintering process can be performed at a temperature lower than 200° C. in the present embodiment. After the implementation of the sintering process, the metal grains 104 are bonded together, so as to form a metal film, a conductive line pattern, an electrode pattern, or any other conductive pattern 200a. Namely, according to the present embodiment, the metal film can be formed in no need of using complicated film-forming equipment and applying complicated film-forming techniques, such as electroplating, sputtering, and so on. What is more, patterning processes, e.g., a photolithography and etching process, are not required for forming a specific metal pattern in the present embodiment, which greatly simplifies the manufacturing method of the metal pattern.

In detail, during the implementation of the sintering process, the MOD molecules 108 attached to the surfaces of the metal grains 104 are self-decomposed (as indicated in FIG. 3), and a metal layer 410 (as shown in FIG. 4) is formed on the surfaces of the metal grains 104 by the metal ions of the MOD molecules 108.

That is to say, energy generated in the sintering process gives rise to transformation of the metal ions of the MOD molecules 108 absorbed on the surfaces of the metal grains 104 into the metal layer 410. In the meantime, an alloy layer 420 is formed between the metal grains 104 and the metal layer 410 by the metal ions of the MOD molecules 108. Since the metal grains 104 and the metal ions of the MOD molecules 108 (the metal layer 410) are made of different metals, the alloy layer 420 is an alloy of the metal grains 104 and the metal layer 410. Namely, after the sintering process is performed, the metal film 200a composed of nano-metal complex grains 400 can be formed on the substrate 300.

In general, after the metal grains 104 in the nanometer scale are sintered and bonded together, ion migration may occur and bring about unfavorable reliability of the metal film or the metal pattern. Nonetheless, according to the present embodiment, the metal film or the metal pattern composed of the nano-metal complex grains 400 can be well protected by the metal layer 410 and the alloy layer 420, and ion migration among the metal grains 104 can also be prevented. As such, the metal film or the metal pattern formed by the nano-metal complex grains 400 can be characterized by satisfactory reliability. On the other hand, the formation of the metal layer 410 and the alloy layer 420 of the nano-metal complex grains 400 is also conducive to an improvement of density of the metal film or the metal pattern.

Note that the nano-metal complex grains 400 are mainly composed of the metal grains 104, while the metal layer 410 and the alloy layer 420 are mere film layers formed on the surfaces of the metal grains 104. In an embodiment, copper can be used to form the metal grains 104 of the nano-metal complex grains 400, and then the metal layer 410 formed on the surfaces of the copper grains 104 is made of silver. That is, the preparation solution 100 can be fabricated by a copper salt, and silver organic self-decomposition molecules are added to the preparation solution 100. As such, in the finally formed nano-metal complex grains 400, the alloy layer 420 between the copper grains 104 and the silver layer 410 is a copper-silver alloy.

Copper is cost-effective but is prone to be oxidized, while silver is cost-consuming but is rather stable. Thus, the nano-metal complex grains 400 having the copper grains 104 and the silver layer 410 save the costs, and the use of the silver layer 410 ensures favorable stability. In conclusion, the metal film formed by the aforesaid nano-metal complex grains 400 is characterized by satisfactory quality and reasonable costs. Certainly, the combination of copper and silver is exemplary, while other combinations of metals can also be applied to form the nano-metal complex grains 400.

In the following, an example and a comparative example are described, and the sheet resistance of the metal films formed in the examples and the comparative example are measured at different temperatures (such as 100° C., 120° C., 130° C. and 150° C.) and shown in Table 1.

### EXAMPLE 1

In Example 1, the preparation solution is prepared by mixing 2 L deionized water (solvent), 20 g copper nitrate, 150 g ascorbic acid and 200 g polyvinyl pyrrolidone (PVP). Nano-copper grains are formed through the reaction of the metal slat and the reducing agent during preparing the preparation solution.

A cleaning process is performed to the preparation solution having the nano-copper grains therein with deionized water to remove the protecting agent on the surfaces of the nano-copper grains in the preparation solution.

After the cleaning process, the preparation solution is prepared to have 40% solid amount of nano-copper grains.

Next, a nano-metal solution is prepared by mixing 10 g the above-mentioned preparation solution, 40 g C₇H₁₅COOAg and 60 g xylene. After the nano-metal solution is prepared, the nano-metal solution is coated onto a glass substrate with a spin coating process.

After that, a sintering process is performed to form a metal film or a metal pattern on the glass substrate. The sintering process is performed at a temperature lower than 200° C. and in a time of 10 minutes. After the sintering process, the nano-copper grains are joined together to form a metal film, a conductive line pattern, an electrode pattern or other conductive pattern. In other words, in the example, a metal film can be formed without using electrical planting, sputtering or other depositing techniques. In particular, a specific metal pattern can be formed without using photolithographic process and etching process, so as to simplify the manufacturing process of the metal pattern.

More specifically, the energy generated during the sintering process allows the metal ions of the metallic-organic self-decomposition molecules on the surfaces of the nano-metal grains to form a metal layer, and the metal ions of the metallic-organic self-decomposition molecules further form a copper-silver alloy layer between the nano-copper grains and the metal layer at the same time.

### EXAMPLE 2

A preparation solution which is prepared with the method the same to the Example 1 having 40% solid amount of nano-copper grains is provided.

Next, a nano-metal solution is prepared by mixing 10 g the above-mentioned preparation solution, 26 g C₇H₁₅COOAg having formula 1 in which M represents silver ion, and 27 g xylene.

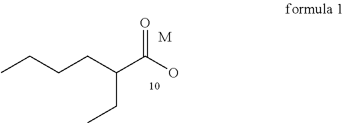

After the nano-metal solution is prepared, the nano-metal solution is coated onto a glass substrate with a spin coating process.

After that, a sintering process is performed to form a metal film or a metal pattern on the glass substrate. The sintering process is performed at a temperature lower than 200° C. and in a time of 10 minutes. After the sintering process, the nano-copper grains are joined together to form a metal film, a conductive line pattern, an electrode pattern or other conductive pattern. In other words, in the example, a metal film can be formed without using electrical planting, sputtering or other depositing techniques. In particular, a specific metal pattern can be formed without using photolithographic process and etching process, so as to simplify the manufacturing process of the metal pattern.

More specifically, the energy generated during the sintering process allows the metal ions of the metallic-organic self-decomposition molecules on the surfaces of the nano-metal grains to form a metal layer, and the metal ions of the metallic-organic self-decomposition molecules further form a copper-silver alloy layer between the nano-copper grains and the metal layer at the same time.

### EXAMPLE 3

A preparation solution which is prepared with the method the same to the Example 1 having 40% solid amount of nano-copper grains is provided.

Next, a nano-metal solution is prepared by mixing 10 g the above-mentioned preparation solution, 11 g C₇H₁₅COOAg having formula 1 in which M represents silver ion, and 13 g xylene.

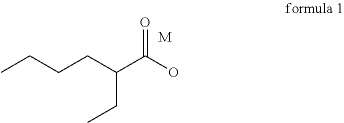

After the nano-metal solution is prepared, the nano-metal solution is coated onto a glass substrate with a spin coating process.

After that, a sintering process is performed to form a metal film or a metal pattern on the glass substrate. The sintering process is performed at a temperature lower than 200° C. and in a time of 10 minutes. After the sintering process, the nano-copper grains are joined together to form a metal film, a conductive line pattern, an electrode pattern or other conductive pattern. In other words, in the example, a metal film can be formed without using electrical planting, sputtering or other depositing techniques. In particular, a specific metal pattern can be formed without using photolithographic process and etching process, so as to simplify the manufacturing process of the metal pattern.

More specifically, the energy generated during the sintering process allows the metal ions of the metallic-organic self-decomposition molecules on the surfaces of the nano-metal grains to form a metal layer, and the metal ions of the metallic-organic self-decomposition molecules further form a copper-silver alloy layer between the nano-copper grains and the metal layer at the same time.

### COMPARATIVE EXAMPLE

In the comparative example, 40 g C₇H₁₅COOAg and 60 g xylene are mixed to form a solution. Next, the solution is spinning coated onto a glass substrate, and then a sintering or baking process is performed to form a metal film on the glass substrate.

The compositions of the metal films, process conditions and sheet resistances of the Example 1 and the comparative example are shown in Table 1.

TABLE 1

| | Compositions of metal | | | Compositions of metal | | | | | |
|---|---|---|---|---|---|---|---|---|---|
| | film before sintering | | | film after sintering | | | | | |
| | | nano-copper | | | nano-copper | Temperature (° C.) | | | |
| | C₇H₁₅COOAg | grains | Xylene | Ag | grains | 100 | 120 | 130 | 150 |
| | (wt %) | (wt %) | (wt %) | (wt %) | (wt %) | Sheet resistance (Ω/□) | | | |
| Comparative | 40 | 0 | 60 | 100 | 0 | none | none | 0.14 | 0.02 |
| Example | | | | | | | | | |
| Example 1 | 38 | 4 | 58 | 81.14 | 18.86 | >1M | 0.20 | 0.05 | 0.02 |
| Example 2 | 46 | 7 | 47 | 56.25 | 43.75 | none | >1M | 0.35 | 0.16 |
| Example 3 | 40 | 14 | 46 | 36.36 | 63.64 | none | >1M | 0.23 | 0.08 |

As shown in Table 1, the nano-copper grains are added during the formation of the metal film in the Examples 1-3, and nano-copper grains are formed into nano-metal complex grains after the sintering process is performed, wherein the nano-metal complex grains are comprised of nano-copper grains, a silver layer and an alloy layer between the nano-copper grains and the silver layer. However, in the comparative example, the nano-copper grains are not used, and thus a simple metal film is formed after the sintering process is performed. The sheet resistances of the metal films formed in example 1 and the comparative example measured at different temperatures (such as 100° C., 120° C., 130° C. and 150° C.) show the metal film of the example 1 has a lower sheet resistance. Thereby, the metal film of the example 1 formed from the nano-metal grains has good electrical characteristic and reliability.

In light of the foregoing, the MOD molecules of the nano-metal solution can be transformed to be the nano-metal complex grains after the sintering process is performed in the present invention. Here, the nano-metal complex grains are constituted by the metal grains, the metal layer, and the alloy layer located between the metal grains and the metal layer. The metal grains of the nano-metal complex grains are protected by the metal layer and the alloy layer, such that ion migration and oxidation do not often arise. As a result, the metal film or the metal pattern formed by bonding the nano-metal complex grains of the present invention is equipped with great electrical properties and reliability. Moreover, in the present invention, the metal layer and the alloy layer of the nano-metal complex grains can be formed on the surfaces of the metal grains by merely performing the sintering process, so as to form the metal film or the metal pattern, without performing complicated film-forming, photolithography, and etching processes, thus simplifying the manufacturing method of the metal film or the metal pattern.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A nano-metal solution, comprising:
a plurality of metal grains having an amount of 0.1˜30 wt %;
a plurality of metallic-organic self-decomposition molecules having an amount of 0.1˜50 wt % and having formula 1: 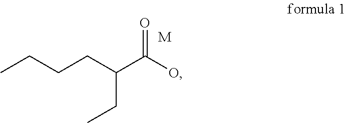
wherein M represents a metal ion; and
a solvent having an amount of 20˜99.8 wt %,
wherein the metallic-organic self-decomposition molecules and the metal grains are evenly mixed in the solvent, and the metallic-organic self-decomposition molecules are adsorbed on surfaces of the metal grains.

2. The nano-metal solution as claimed in claim 1, wherein the metallic-organic self-decomposition molecules have a self-decomposed temperature lower than 200° C.

3. The nano-metal solution as claimed in claim 1, wherein the metal grains comprise copper grains, silver grains, gold grains, aluminum grains, titanium grains, nickel grains, or a combination thereof.

4. The nano-metal solution as claimed in claim 1, wherein the metal ion M comprises copper ion, silver ion, gold ion, aluminum ion, titanium ion, nickel ion, or a combination thereof.

5. The nano-metal solution as claimed in claim 1, wherein the metal grains and the metal ion are different metals.

6. The nano-metal solution as claimed in claim 1, wherein diameters of the metal grains are less than 100 nm.

7. The nano-metal solution as claimed in claim 1, wherein the solvent comprises water or an organic solvent.

8. A nano-metal complex grain, comprising:
a plurality of metal grains;
a metal layer, covering surfaces of the metal grains; and
an alloy layer, located between the metal grains and the metal layer, wherein the alloy layer is an alloy of the metal grains and the metal layer, and the metal grains are bonded together.

9. The nano-metal complex grain as claimed in claim 8, wherein the metal grains and the metal layer are different metals.

10. The nano-metal complex grain as claimed in claim 8, wherein diameters of the metal grains are less than 100 nm.

11. The nano-metal complex grain as claimed in claim 8, wherein the metal grains comprise copper grains, silver grains, gold grains, aluminum grains, titanium grains, nickel grains, or a combination thereof.

12. The nano-metal complex grain as claimed in claim 8, wherein a material of the metal layer comprises copper, silver, gold, aluminum, titanium, nickel, or a combination thereof.
